(19) United States
(12) Patent Application Publication
(10) Pub. No.: US 2006/0062223 A1
(43) Pub. Date: Mar. 23, 2006

(54) Delay-reduced stall avoidance mechanism for reordering a transport block

(75) Inventors: Gregory Manuel, Helsinki (FI); Mika P. Rinne, Espoo (FI)

Correspondence Address: Alfred W. Froebrich, Esq.;Cohen, Pontani, Lieberman & Pavane, Suite 1210, 551 Fifth Avenue, New York, NY, 10176, US

(73) Assignee: Nokia Corporation

(21) Appl. No.: 11/209,232

(22) Filed: Aug. 23, 2005

Related U.S. Application Data
(60) Provisional application No. 60/611,005, filed on Sep. 17, 2004.

(51) Int. Cl. H04L 12/56

(52) U.S. Cl. 370/394; 370/392

(57) ABSTRACT

A method for implementing a stall avoidance mechanism during uplink transmission of data blocks from transmitter to a receiver includes first determining a missing data block in response to a successful receipt of a received data block at the receiver. Once the missing data block is determined, the receiver requests retransmission of the missing data block. The receiver starts a timer when the request for retransmission is made such that the timer has a time value based on the number of reception attempts of the received data block made by the receiver.

### RELATED APPLICATIONS

This application claims priority from U.S. Provisional Patent Application Ser. No. 60/611,005 which was filed on Sep. 17, 2004.

### BACKGROUND OF THE INVENTION

1. Field of the Invention

The present invention relates to a method for implementing timer-based stall avoidance for High Speed Uplink Packet Access.

2. Description of the Related Art

The High Speed Uplink Packet Access (HSUPA), which is also referred to as Enhanced uplink Dedicated Channel (E-DCH), is a work item in the 3GPP RAN standardization to define the enhanced uplink transport of the WCDMA [Ref. 3GPP TS25.309 V6.1.0 (2004-12)]. One of the key targets of the concept is to reduce the packet delays over the air interface. Novel physical and Media Access Control (MAC) layer functionalities at the terminal, Node B, and RNC are proposed for the E-DCH. Fast L1/MAC retransmissions using a multiple channel Stop and Wait (SAW) Automatic Repeat reQuest (ARQ) mechanism is one of the features implemented to reduce delays of the Transport Blocks (TBs) for E-DCH.

The same multi-channel SAW ARQ mechanism used in the WCDMA system with High Speed Downlink Packet Access (HSDPA) was selected for HSUPA. For optimum performance, the Radio Layer Control (RLC) requires the data blocks to be received in-sequence to the greatest extent possible. However, the implementation of the multi-channel SAW ARQ mechanism at L1/MAC layer for the E-DCH may cause a different number of transmission attempts to be required for each data block so that the in-sequence reception of the data blocks at the receiver cannot be assured. Therefore, a reordering entity is needed to forward the data blocks to RLC.

Protocol stalling of the multi-channel SAW ARQ mechanism is a know problem when used in a wireless channel. The stalling situation occurs when the receiver is waiting for a packet to be retransmitted, while the transmitter thinks that it has been correctly received and therefore will never retransmit that packet.

A timer mechanism is usually used to prevent indefinite stalling. However, the timer mechanism can cause significant transmission delays. One drawback of the timer mechanism is that it will sometimes add unnecessary delay to the Protocol Data Unit (PDU) delivery to the RLC layer, degrading the performance in terms of Service Data Unit (SDU) delay and throughput.

The data blocks to be transmitted may each be associated with a Sequence Number (SN) at the transmitter for purposes of allowing reordering to be performed by the reordering entity. The following is a simple example to illustrate the problematic situation. According to the example, a receiver notices that there is a missing data block with sequence number SN=1 in its window, because the receiver received a block with higher sequence number SN=2 and buffered it in the reordering queue at the position given by its SN. The receiver then requests retransmission and starts a timer (if it was not already active, i.e., only one timer is activated per reordering queue) associated with the received SN=2 and which runs for all the blocks with lower SN's of the window. While waiting for the missing SN to be received such as, for example, from an ARQ process, the receiver is able to receive more data blocks with higher SNs and add the additional data blocks to the buffer. The timer is used to prevent stalling of the protocol, i.e., the receiver will not wait indefinitely for a missing block that will never arrive. With the timer, we are sure that we are waiting for a missing block only a limited time set by the timer parameter.

However, there are cases where the timer is active and runs in wait for a missing block that will actually never be retransmitted. This situation adds unnecessary delay to the RLC selective ARQ that could have received the correctly buffered data much before and could therefore produce an earlier RLC STATUS PDU to require the RLC retransmission of the missing data. In such a situation, the number of RLC data blocks (i.e. RLC PDUs) delayed may be very large, because the data blocks may be large in size and several correctly decoded data blocks may wait for a single missing data block to appear.

Examples of situations where the receiver is waiting for a missing block that will not get retransmitted include (1) when the Layer 1 data block acknowledgement has been misinterpreted (p {ACK | NACK} or p {ACK | DTX}) or (2) when the data block has been discarded by the transmitter (e.g. the maximum number of transmission attempts was hit). According to the currently known solutions such as the solution used for High Speed Downlink Packet Access (HSDPA), use of timer stall avoidance causes the reordering queue to wait until the timer expires to skip the missing block in the higher layer delivery.

### SUMMARY OF THE INVENTION

The present invention uses timer and window based stall avoidance mechanisms similar to those used for (HSDPA) (Ref 3GPP TS 25.321 V5.3.0) for the E-DCH due to the introduction of a multiple-channel Stop And Wait Automatic Repeat reQuest (N-channel SAW ARQ). The present invention allows the receiver window to be adapted to the transmitter window by having a more stringent and accurate setting of the stall timer. The timer is activated when a correctly decoded data block is received before a missing data block of a lower-sequence number than the correctly decoded data block. The receiver sets the stall timer initial value dynamically at the moment of activation, based on the prior art rules, but additionally takes the number of reception attempts of the correctly decoded data block into account. Based on this indication, a more stringent timer setting is determined which reduces the transmission delay while still avoiding stalling.

The number of reception attempts of the correctly decoded data block gives us how much time was already spent attempting to retransmit the missing Transport Block (TB) which has a lower sequence number than the correctly decoded data block. This comes from the multiple-channel SAW ARQ characteristics, requiring that there should be at least N*TTI period of time separating two consecutive transmission attempts of the same TB, where N is the number of the channels of the multiple-channel SAW ARQ and TTI is the transmission time interval. The transmission time interval is defined as the inter-arrival time of a transport block set (TBS), which is equal to the periodicity at which a TBS is transferred by the physical layer on the radio interface. In the synchronous case, this timing is exactly equal to N*TTI, while in the asynchronous it is greater than or equal to N*TTI.

The inventive procedure will set the stall timer to a specific value which more accurately reflects the time that the receiver should wait for retransmissions of missing data blocks with lower SNs than in prior art. The invention works the same way with synchronous and asynchronous schemes.

When the receiver notices that the conditions to activate the timer are fulfilled, the receiver sets the timer in the reordering queue to a value based on N-channel SAW ARQ delay (i.e., N*TTI), the number of reception attempts of the correctly received block (i.e. the block that triggers the activation of the timer); and the timer setting. The timer value is given by the formula:
Timer=Max(T_Initial−[(N*TTI)*(Reception_Number−1)],0) [1]
wherein:

T_Initial is the timer setting;

N is the number of ARQ processes;

TTI is the TTI length; and

Reception_Number is the number of reception attempts of the correctly received block.

One way to parameterize the timer setting (i.e., T_Initial) is to compute the maximum time that a TB could wait to be retransmitted before being discarded. In a synchronous mode, this time is exactly given as:
T_Initial=[(Max_Retransmissions_Number*N)−1]*TTI [2]
wherein:

T_Initial—is the timer setting;

Max_Retransmissions_Number—is the maximum number of retransmissions of a TB;

N—is the number of ARQ processes; and

TTI—is the TTI length.

The above formulas use the fact that the air interface delay using SAW ARQ channels depends on the number of ARQ processes (N)*TTI length and that retransmissions are prioritized for each ARQ or hybrid ARQ process in the reordering queue. According to the above formulas, the timer is set to run for a time comprising an initial timer setting reduced by a reduction value of (N*TTI)*(Reception_Number−1).

Furthermore, the above described solution requires that the following parameters are known at the reordering queue: the number of ARQ processes, the TTI length, the number of reception attempts of the correctly received TB, and the timer setting. The timer setting may be determined from the number of ARQ processes, the TTI length, and the maximum number of retransmissions of a TB.

The invention will reduce the delays in specific cases where the RLC PDUs in the correctly decoded TBs would unnecessarily wait for a missing TB (stall situation) until the timer triggers.

The current specification regarding the timer-based stall avoidance mechanism for HSDPA (Ref. 3GPP TS 25.321 V5.3.0, p50) may be modified for the HSUPA case according to the present invention in accordance with the following paragraph.

The Re-ordering release timer T1 controls the stall avoidance in the RNC reordering buffer. The set up value of T1 is computed based on upper layers signaling, the number of ARQ processes specified, the TTI length and the number of reception attempts of the block triggering the activation of the timer. The Re-ordering release timer T1 shall be set based on equation [1] described above:

The following conditions are known from the present specification for the timer-based stall avoidance mechanism for HSDPA and are also applicable for the HSUPA case.

(1) If no timer T1 is active:
the timer T1 shall be started when a MAC-e PDU with TSN=SN is correctly received but can not be delivered to the disassembly function due to that the MAC-e PDU with TSN equal to Next_expected_TSN is missing.

(2) If a timer T1 is already active:
no additional timer shall be started, i.e. only one timer T1 may be active at a given time.

(3) The timer T1 shall be stopped if:
the MAC-e PDU for which the timer was started can be delivered to the disassembly function before the timer expires.

(4) When the timer T1 expires:
all correctly received MAC-e PDUs up to and including SN-1 shall be delivered to the disassembly function and they shall be removed from the reordering buffer and be considered as having been received; and
all correctly received MAC-e PDUs up to the next missing MAC-e PDU shall be delivered to the disassembly function.

(5) When the timer T1 is stopped or expires, and there still exist some received MAC-e PDUs that can not be delivered to higher layer:
timer T1 is started for the MAC-e PDU with highest TSN among those MAC-e PDUs that can not be delivered.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a schematic diagram of an example of a Radio Access Network in which the present invention is implemented;

FIG. 2 is a schematic depiction of first through fifth process allocation according to the present invention;

FIG. 3 is a schematic depiction of third through sixth process allocation according to the prior art;

FIG. 4 is a table comparing the Transport Block delay of the inventive method of FIG. 2 and the prior art method of FIG. 3;

FIG. 5 is a flow chart of the reordering mechanism according to the present invention; and

FIG. 6 is a flow chart of the proposed new timer stall avoidance setting.

### DETAILED DESCRIPTION OF THE PREFERRED EMBODIMENTS

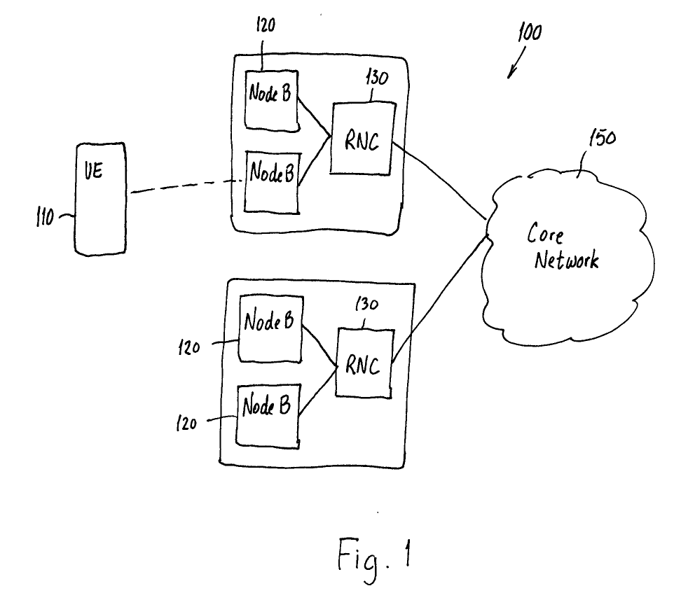

FIG. 1 is a schematic diagram of an example of a network in which the present invention is implemented. A Radio Access Network (RAN) 100 includes a User Equipment (UE) 110 in communication with at least one base station, i.e., Node B 120, of a plurality of base stations such as Node Bs 120. Each of the Node Bs 120 is connected to a Radio Network Controller (RNC) 130 which is connected to a core network 150. The RNCs 130 communicate with each other and are, e.g., responsible for handover decisions. The present invention relates to uplink transmissions and includes transmissions from a UE 110 to a Node B and transmissions from a Node B 120 to an RNC 130. Each of the UE 110, Node B 120, and RNC 130 include processors for processing data as described below. The processors may include specifically designed hardware or may be arranged to run programs for performing the functions described below.

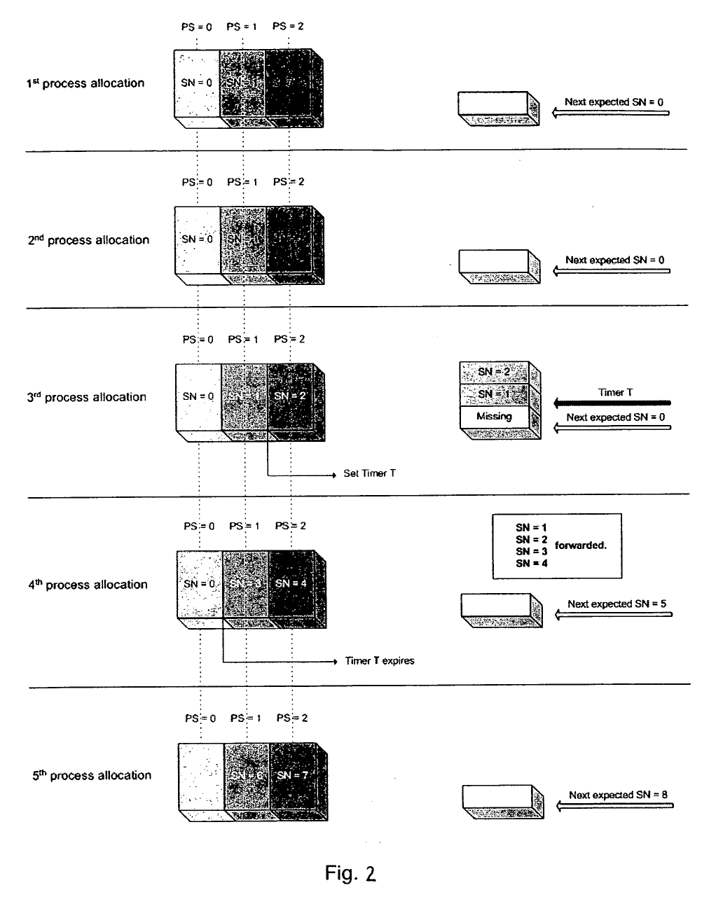

FIG. 2 shows allocations for the first through fifth transmissions of three synchronous processes PS 0, 1, 2 in an uplink receiver according to an example using the method of the present invention. According to the illustrative example, there are a maximum of four transmission attempts per process for each data block. According to FIG. 2, all three processes PS 0, 1, 2 fail to correctly decode the datablocks SN 0, 1, 2, respectively, in the first two process transmissions. On the third process transmission, SN 1, 2 are correctly decoded and SN 0 is not correctly decoded. Accordingly, SN 1, 2 are buffered in the reordering queue. Once SN 1 is received, it is determined that SN 0 is missing and a timer T is started. The timer is set according to the following equation [1]:
Timer=Max(T_Initial−[(N*TTI)*(Reception_Number−1)],0) [1]
wherein:

T_Initial—is the timer setting from upper layer signaling;

N—is the number of ARQ processes;

TTI—is the TTI length; and

Reception_Number—is the number of reception attempts of the correctly received block.

T_Initial is defined by the following equation [2]:
T_Initial=[(Max_Retransmissions_Number*N)−1]*TTI [2]
wherein:

Max_Retransmissions_Number—is the maximum number of retransmissions of a TB;

N—is the number of ARQ processes; and

TTI—is the TTI length.

In the present example, there are a maximum of four transmission attempts per process for each data block. Accordingly, the maximum number of retransmissions is three. There are three ARQ processes (PS 0, 1, 2). Using Equation [2], the timer setting T_Initial is ((3*3)−1)*TTI=8TTI.

In the above example, SN 1 is correctly received after the third reception attempt. According to Equation [1], the timer is set to 8TTI−(3*TTI)*(3-1)=2TTI.

In the fourth transmission in FIG. 2, processes PS 0, 1, 2 transmit SN 0, 3, 4. Only SN 3, 4 are correctly decoded. Since the Timer is active for only two TTIs, the timer expires in the fourth transmission and SN 1, 2, 3, and 4 are forwarded. Processes PS 0, 1, 2, transmit SN 5, 6, 7 in the fifth transmission.

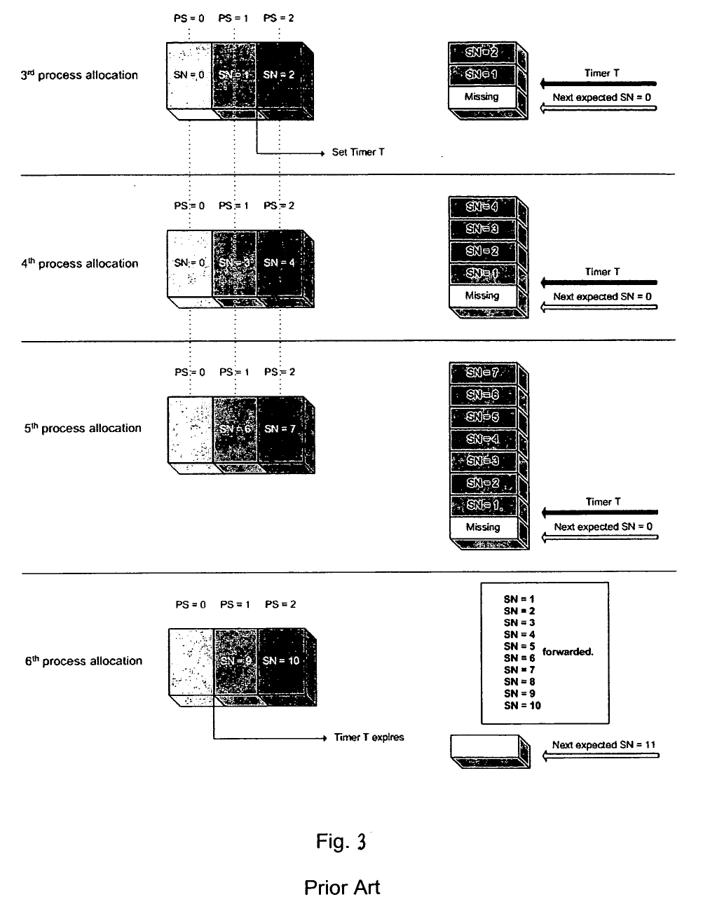

FIG. 3 shows the allocations of the third through the sixth transmissions of processes PS 0, 1, 2 using the same data as the example in FIG. 2 according to the prior art without using the inventive method. The allocations of the first and second process allocation are the same as those shown in FIG. 2. Since the timer is not limited or reduced, as in the present invention, the timer is active in this example, for eight TTIs (T_Initial is not reduced) and expires in the sixth transmission. The blocks SN 1, 2, 3, 4, 5, 6, 7, 8, 9, and 10 are forwarded at the sixth transmission.

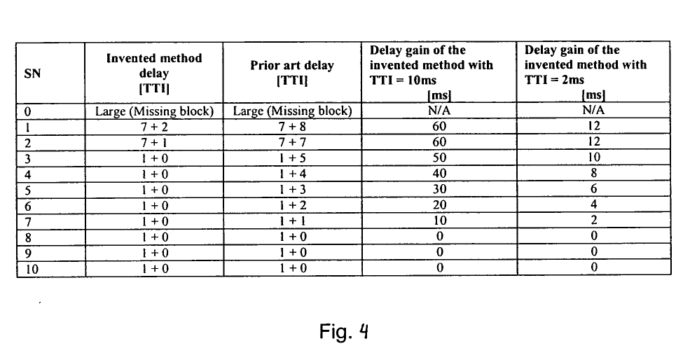

FIG. 4 is a table showing the Transport Block delay including reordering with timer stall avoidance mechanism. The inventive method delay is based on FIG. 2 and the prior art delay is based on FIG. 3. The invented method delay and prior art delay columns show the TB delay in number of TTIs, split in two components, the transmission delay+the timer stall avoidance mechanism delay. The two last columns show the respective delay gain per TB for 10 and 2 ms TTI length that the proposed invention achieves.

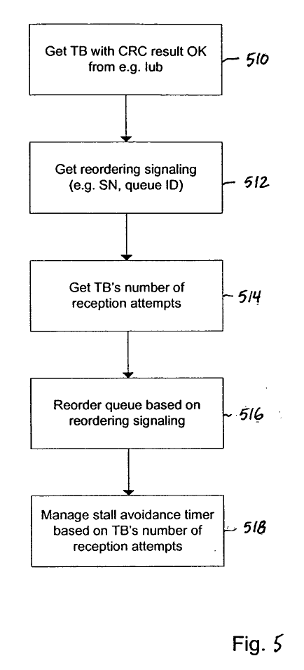

FIG. 5 is a flowchart introducing the high level description of the reordering mechanism including improved timer stall avoidance feature. In step 510, the transport block (TB) with a Cyclic Redundancy Code (CRC) result is received, e.g., at the RNC from the Node B via Iub. Reordering signaling is then retrieved for the current reception, e.g., the SN, queue ID for the received TB, step 512. The number of reception attempts is determined for the TB after the missing block, i.e., the TB that triggers the activation of the timer, step 514. In step 516, the queue is then reordered based on the reordering signaling determined in step 512. In step 418, the stall avoidance timer is managed in accordance with the number of reception attempts determined in step 514.

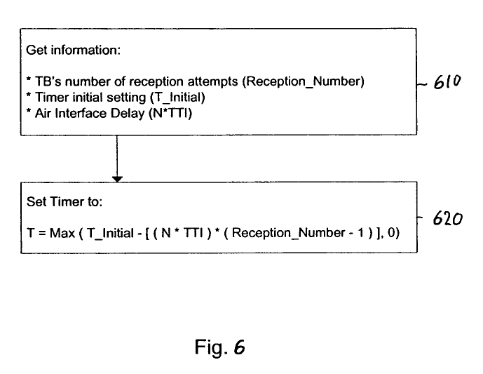

FIG. 6 is a flowchart of the proposed new timer stall avoidance setting. In step 610, the number of reception attempts of the correctly received TB which triggers the activation of the timer setting, the timer initial setting T_Initial and the air interface delay N*TTI are determined. As described above, N is the number of ARQ processes and TTI is the TTI length. The timer initial setting T_Initial is given in Equation [2]. In step 620, the timer is set in accordance with Equation [1].

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for implementing stall avoidance during uplink transmission of data blocks from a transmitter to a receiver, comprising the steps of:
determining a missing data block in response to successful receipt of a received data block at the receiver;
requesting, by the receiver, a retransmission of the missing data block; and
starting a timer having a time value based on the number of reception attempts of the received data block made by the receiver.

2. The method of claim 1, wherein said time value comprises an initial timer setting reduced by a reduction value, the reduction value being based on the number of reception attempts of the received block made by the receiver.

3. The method of claim 2, wherein the initial timer setting is based on the maximum number of transmission attempts allowed by the transmitter.

4. The method of claim 2, wherein the initial time setting is based on the following equation:
T_Initial=[(Max_Retransmissions_Number*N)−1]*TTI
wherein:
Max_Retransmissions_Number—is the maximum number of retransmissions of a block allowed by the transmitter;
N—is the number of repeat request processes; and
TTI—is the length of the transmission time interval.

5. The method of claim 2, wherein the time value is based on the following equation:
Timer=Max(T_Initial−[(N*TTI)*(Reception_Number−1)],0)
wherein:
T_Initial—is the timer setting from upper layer signaling;
N—is the number of repeat request processes;
TTI—is the length of the transmission timing interval; and
Reception_Number—is the number of reception attempts of the received data block made by the receiver.

6. The method of claim 5, wherein the initial time setting is based on the following equation:
T_Initial=[(Max_Re transmissions_Number*N)−1]*TTI
wherein:
Max_Retransmissions_Number—is the maximum number of retransmissions of a block allowed by the transmitter;
N—is the number of repeat request processes; and
TTI—is the length of the transmission time interval.

7. The method of claim 1, wherein the method is used with High Speed Uplink Packet Access.

8. The method of claim 7, wherein the method is in accordance with technical specification 3GPP TS 25.309.

9. The method of claim 1, further comprising the step of starting the timer when a protocol data unit is correctly received but can not be delivered to a disassembly function in the receiver because another protocol data unit having a sequence number equal to a next expected sequence number of the receiver is missing.

10. The method of claim 9, wherein the timer is stopped when the missing protocol data unit for which the timer was started is deliverable to the disassembly function of the receiver.

11. The method of claim 1, wherein said step of starting a timer includes determining whether a previous timer is active and not starting the timer if the previous timer is active.

12. The method of claim 1, further comprising the step of delivering all correctly received data blocks to a disassembly function of the receiver when the timer expires and the missing data block is not received.

13. The method of claim 1, wherein a second missing data block is determined, and further comprising the steps of determining whether the timer is active and not starting a further timer if the timer is active.

14. The method of claim 13, further comprising determining that some of the correctly received data blocks are undeliverable to a higher layer in the receiver when the timer expires and starting a further timer for the undeliverable data block having the highest serial number of the undeliverable data blocks.

15. The method of claim 1, further comprising the step of retrieving, by the receiver, reordering signaling for the current reception including the sequence number and queue ID for the received block.

16. A network element for receiving uplink transmissions comprising a processor arranged and dimensioned for determining a missing data block in response to successful receipt of a received data block at the receiver, generating a request for a retransmission of the missing data block, and starting a timer having a time value based on the number of reception attempts of the received data block made by the receiver.

17. A network element of claim 16, wherein said network element comprises a base station.

18. A network element for receiving uplink transmissions comprising a memory storing computer executable instructions for:
determining a missing data block in response to successful receipt of a received data block at the receiver;
requesting, by the receiver, a retransmission of the missing data block; and
starting a timer having a time value based on the number of reception attempts of the received data block made by the receiver.

19. A network element of claim 18, wherein said network element comprises a base station.
